(19) United States
(12) Patent Application Publication
(10) Pub. No.: US 2010/0102079 A1
(43) Pub. Date: Apr. 29, 2010

(54) FLUID NOZZLE

(76) Inventor: Lovro GOTOVAC, Woodbridge (CA)

Correspondence Address: MILLER THOMPSON, LLP, Scotia Plaza, 40 King Street West, Suite 5800, TORONTO, ON, M5H 3S1, CA

(21) Appl. No.: 12/259,505

(22) Filed: Oct. 28, 2008

(51) Int. Cl. G01F 11/00; B67D 7/58; B67D 5/40

(52) U.S. Cl. 222/1; 222/372; 222/383.3

(57) ABSTRACT

This invention relates to a hand pump adapted for discharging fluid from a portable container, and particularly relates to a hand pump having a first and second valve means for discharging fluid from a portable container. The invention also relates to a method of discharging fluid from a portable container by use of a hand pump.

### FIELD OF THE INVENTION

This invention relates to a hand pump adapted for discharging fluid from a portable container, and particularly relates to a hand pump having a first and second valve means for discharging fluid from a portable container. The invention also relates to a method of discharging fluid from a portable container by use of a hand pump.

### BACKGROUND TO THE INVENTION

Various devises and methods have heretofore been used in the prior art to deliver fluid from one position to another. Such devices and methods include electrical pumps for pumping gasoline into automobiles or the lake. Other devices include hand pump devices particularly when delivering fluid from a gasoline container to a lawn mower or power boat. In some cases, the user typically manipulates a gasoline container that is tipped to deliver gasoline to a lawn mower or outdoor motor. Such devices and methods however can cause spillage over the lawn mower or gasoline motor and in some cases can be dangerous.

Prior art devices include the fluid dispensing nozzle construction disclosed in U.S. Pat. No. 4,971,121 which relates to a belt construction that comprises a valve body having a dispensing spout extending therefrom, and a flexible bellows-like tube of polymeric material telescopically disposed on the spout and having opposed ends, one of which is secured to the valve body and the other which carries a face seal for engaging an annular lip.

Another device is disclosed in U.S. Pat. No. 5,007,468 which relates to a fluid dispensing nozzle construction having a diaphragm sub-assembly comprising a pin, a diaphragm support carried by the pin, a diaphragm, and a diaphragm retainer securing the diaphragm to the pin with the diaphragm being disposed and sandwiched between the diaphragm retainer and the diaphragm support.

Yet another arrangement is shown in U.S. Pat. No. 5,127,451 which relates to a fluid dispensing nozzle having a body in which fluid passage is formed.

Another arrangement is shown in U.S. Pat. No. 5,273,087 which relates to a nozzle having a spout assembly comprising a fuel conduit for flow of gasoline or other liquid volatilizable hydrocarbon fuel in a fill opening or fill pipe into a customer's tank.

Another fluid nozzle is disclosed in U.S. Pat. No. 5,992,479 which relates to a venturi shut off mechanism and an electronic pressure switch shut off mechanism.

Furthermore U.S. Pat. No. 6,126,047 and U.S. Pat. No. 7,082,972 each relate to a different fluid dispensing nozzle.

Also U.S. Pat. No. 7,134,580 relates to a spout assembly for dispensing liquid from a nozzle.

U.S. Publication No. 2002/0189708 relates to a liquid supply nozzle having automatic shut down and a alarm function which will stop feeding a liquid when a diaphragm is damaged.

Finally United States Patent Public No. 2006/0260712 relates to a fluid dispensing nozzle including a body, a handle connected to the body, a handle guard connected to the body and generally surrounding the handle, and a spout extending from the body.

Accordingly there is a need to provide an improved hand pump for dispensing fluid such as gasoline from a container which is both reliable, easy to use and safe.

These and other objects and features of the invention shall now be described in relation to the following drawings.

It is an aspect of the invention to provide a hand pump adapted to discharge fluid from a portable container comprising: means for reversibly attaching the hand pump to the portable container; means for directing fluid from the portable container into a receiving container; means for allowing the fluid to flow from the portable container to the receiving container; and means for causing the fluid to cease flowing from the portable container to the receiving container.

It is another aspect of the invention to provide A hand pump adapted to discharge fluid from a portable container comprising: a handle having a handle passage extending therethrough; a nozzle having a nozzle passage extending therethrough; a fluid chamber having a lower fluid reservoir associated at one end with the handle passage and at the other end with a first end of an upper fluid reservoir, wherein a second end of the upper fluid reservoir is associated with the nozzle passage; a piston movable within the upper fluid chamber; a trigger pivotally attached at a first end to an external end of the piston, and at a medial position to a first end of the handle; a fitting disposed between the second end of the upper reservoir and the spout; a first needle extending through the upper reservoir from the internal end of the piston through the fitting into the nozzle passage; a first spring extending coaxially along the first needle from the internal end of the piston to the fitting; a first valve slidably mounted coaxially on the nozzle end of the first needle; a second spring disposed between the first valve and the nozzle end of the needle; a second needle in the lower reservoir having a second valve slidably mounted on its end; a fitting adapted for connection of the nozzle to a portable container.

Yet another aspect of this invention relates to a method of discharging fluid from a hand pump connected to a portable container said hand pump having an inlet and outlet. comprising: attaching a fluid conduit from the inlet to the portable container; the hand pump having a first and second reservoir, and a channel there between; displacing a trigger associated with the hand pump so as to displace a piston in the first reservoir and: open a first valve associated with the first reservoir, so as to discharge fluid from the first reservoir to the outlet; close a second valve associated with the second reservoir in a fluid discharge position; displacing the trigger associated with the hand pump so as to displace the piston in the first reservoir and: close the first valve associated with the first reservoir; open the second valve associated with the second reservoir so as to fill the first and second reservoir with fluid from the portable container, in a fluid drawing position.

### DESCRIPTION OF THE DRAWINGS

At FIG. 1 is a perspective view from the front of the hand pump.

FIG. 2 is a perspective view from the rear of the hand pump.

FIG. 3 is a top plan view of the hand pump.

FIG. 4 is a cross sectional view of the hand pump taken along the lines A-A of FIG. 3.

FIG. 5 is another cross section view of the hand pump with the trigger in the open position.

FIG. 6 is another cross section view of the hand pump with the trigger in the closed position.

FIG. 7 is an end view of the hand pump.

FIG. 8 is a bottom view of the handle of the hand pump.

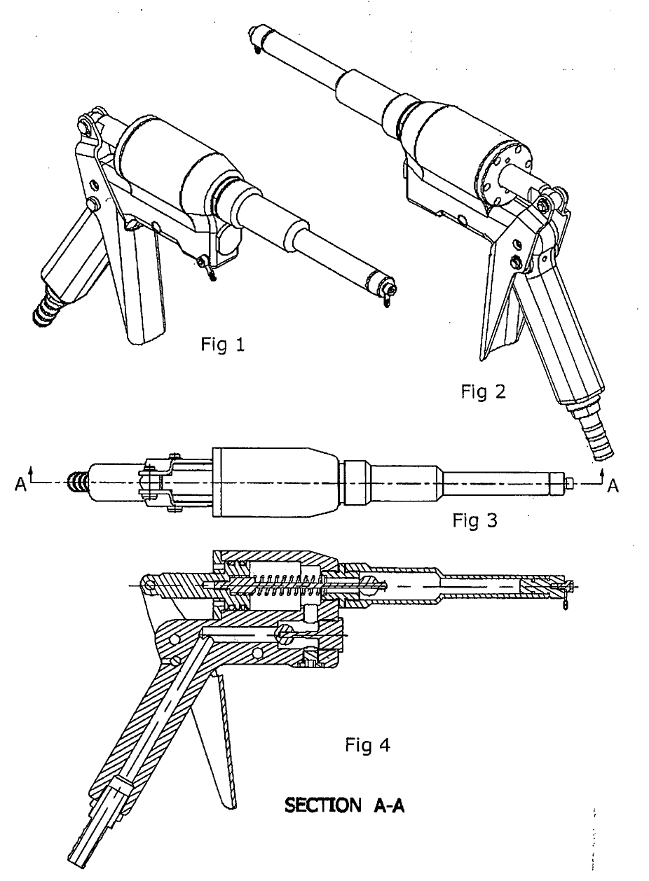

### DETAILED DESCRIPTION OF THE INVENTION

In the drawings, preferred embodiments of the invention are illustrated by way of example. It is to be expressly understood that the description and drawings are only for the purpose of illustration and as an aid to understanding, and are not intended as a definition of the limits of the invention.

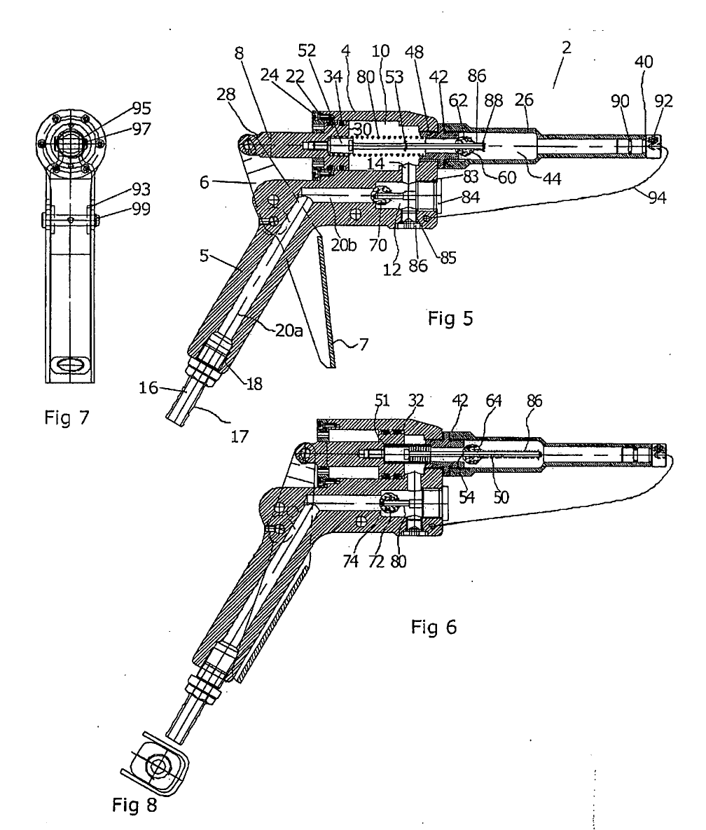

FIG. 5 generally discloses the hand pump 2 which comprises a body 4 having a handle 5 with a trigger 6 and piston 8.

The hand pump 2 also includes a fluid chamber which comprises a first fluid reservoir or upper reservoir 10 and a second or lower fluid reservoir 12. The upper and lower reservoirs are connected together by a channel or passage way 14.

The hand pump 2 is adapted to be connected to a portable fluid container or vessel (not shown) by means of a connection 17 which is adapted to be connected to a fluid conduit (not shown) that connects the inlet 16 of the hand pump 2 to a fluid container (not shown) by means of a fluid conduit (now shown).

The handle 5 includes a passage way 20a which communications with passage 20b disposed in the body 4 as shown in FIG. 5.

The passage 20 communicates with the inlet 16 so as to provide a passage for the fluid being drawn from the fluid container (not shown). The passage 20b communicates with the second or lower fluid reservoir 12 as shown.

The first fluid reservoir or chamber 10 is formed in the body 4 by any number of means including milling or drilling into the body so as to provide the chamber as shown. The chamber can be closed by means of a cover 22 which is attached to the body by means of screws 24.

The hand pump 2 is adapted to discharge fluid from a portable vessel or container (not shown) which comprises means for reversibly attaching the hand pump 2 to the portable container, means for directing fluid from the portable container into a receiving container (not shown); means for allowing the fluid to flow from the portable container to the receiving container; and means for causing the fluid to cease flowing from the portable container to the receiving container.

In particular the means for reversibly attaching the hand pump 2 to the portable container (not shown) comprises a fitting 17 connected to the hand pump 2 wherein the fitting 17 has a sealable adapter of a size and connection mechanism selected to reversibly connect to an opening in the portable container.

Moreover the means for directing fluid from the portable container (not shown) into a receiving container (not shown) comprises an elongated nozzle 26.

The piston 8 includes an exterior end 28 which extends exteriorly of the hand pump 2 and an interior end 30 which is disposed in one end of the upper reservoir 10 as shown in the figures. The interior end of the piston 30 includes grooves 32 which are adapted to retain O-rings 34 and so as to provide a fluid type seal as shown.

The piston 8 is adapted to move or be displaced within the upper fluid reservoir 10 from the position shown in FIG. 5 to the discharge position shown in FIG. 6. The piston 8 and particularly the inner end 30 slides within the inner cylindrical bore of the upper reservoir in a tight manner so as to discharge the fluid in a manner to be disclosed herein.

The nozzle 26 connected to the first end of the upper reservoir 10 has an outlet 40 and an opposed second end 42.

A second passage 44 extends from the upper reservoir 10 through the nozzle 26 to the outlet 40.

A fitting 48 is disposed between the upper reservoir 10 and the nozzle 26 so as to connect the two together.

An activator 50 extends from the internal end 30 of the piston 8 through the upper reservoir 10 through the fitting 48 into the second passage 44 through the nozzle 26 for opening and closing a first valve 60 as shown.

The activator 50 comprises a needle 52 extending from the internal end 30 of the piston 8 through the upper reservoir 10 through the fitting 48 into the second passage 44 within the nozzle 26 wherein the needle 52 has an annular protrusion 53 at a medial position 54 having an external diameter less than the internal diameter of the fitting 48.

The first valve 60 comprises a spherical stopper 62 has a hollow central channel 64 slidably connected to the needle 52 within the second passage 44 wherein the external diameter of the stopper 62 is greater than the internal diameter of the fitting 48. In this way the fitting 48 presents a valve seat while the spherical stopper 62 presents the valve.

The hand pump 2 includes a trigger 6 attached to a first end of the external end of the piston 28 and at a medial position to the handle 5 about pin 99, whereby movement of the second end of the trigger 7 about pin 97 between an open position and a closed position as shown in FIGS. 5 and 6 affects inward movement of the piston 8 and the activator 50 or needle 52 to cause the protrusion 53 to dislodge the spherical stopper 62 from the valve seat and particularly the fitting 48 and allow fluid flow through the outlet 40.

Therefore when the piston 8 is moved from the open trigger position as shown in FIG. 5 to the closed position shown in FIG. 6 fluid in the first fluid chamber 10 is pushed forward with respect to FIG. 5 so that the fluid pressure flows into the second fluid chamber 12 thereby pushing the second valve 70 so as to stop the communication of fluid between the passage 20b and the second fluid reservoir 12. At the same time the fluid in the first fluid chamber 10 is pushed forwardly against the first spherical stopper 62.

The means for causing the fluid to cease flowing from the portable container to the receiving container comprises a first spring 80 which extends between the internal end 30 of the piston 8 and the first end of the fitting 48 wherein the first spring 80 is in equilibrium in the trigger open position as shown in FIG. 5 and compressed in the trigger close position shown in FIG. 6. Furthermore a second spring 86 extends between the second side of the spherical stopper 60 and a second end of the needle 52 wherein the second spring 86 is an equilibrium state in the trigger closed position shown in FIG. 6 and a compressed state in the trigger open position shown in FIG. 5.

The hand pump 2 also includes a positioner 90 for positioning the second valve 70 adjacent to the passage 20b.

The positioner 80 comprises a stationary or second needle 80 which is adapted to be received by a cylindrical hole 72 which does not extend through the second spherical stopper 70. Accordingly as the fluid pushes against the second spherical stopper 72 it pushes against the valve seat 74 presented by the second passage 20b so as to stop the back flow of fluid back into the fluid container.

The positioner or second needle 80 comprises a cylindrical extension from the plug 84 that is screwed into an end of the second fluid reservoir as shown. Another plug 86 is also screwed into the body 4. The plug 86 blocks off a hole formed to the second fluid reservoir 12 when the channel or passage 14 is milled or drilled into the body in the forming stage. The plugs 84 and 86 include threads 83 and 85 so as to threadedly engage the body 4 in a fluid tight manner. A retaining ring 88 is retained in an annular groove presented by the needle 54 so as to retain the second spring 86 as shown in the drawings.

A plug 92 is adapted to engage the outlet 40 and is connected to the hand pump 2 by means of a cable 94. Also the plug 92 includes o-rings 90 so as to prevent the escape of any fluid in the passage 44.

The hand pump 2 includes pins 97 and 99 as well as a retaining ring 95 and a washer 93.

Accordingly the hand pump 2 can be used to discharge fluid from a portable container (not shown). The hand pump 2 has a handle 5 and a handle passage 20a extending therethrough, a nozzle 26 having a nozzle passage 44 therethrough. The hand pump 2 also has a fluid chamber having a lower fluid reservoir 12 associated at one end with the handle passage 20a, 20b and at the other end with a first end of an upper fluid reservoir 10, wherein a second end of the upper fluid reservoir 10 is associated with the nozzle passage 44.

Also the piston 8 is movable within the upper fluid chamber 10. The trigger 6 is pivotally attached at a first end to an external end 28 of the piston 8 and at the medial position to a first end of the handle 5.

A fitting 48 is disposed between the second end of the upper reservoir 10 and the nozzle 26. A first needle 52 extends through the upper reservoir 10 from the internal end 30 of the piston 8 through the fitting 48 into the nozzle passage 44. A first spring 80 extends coaxially along the needle 52 from the internal end 30 of the piston 8 to the fitting 48. A first valve 60 is slidably mounted coaxially on the nozzle end of the needle 52. A second spring 86 is disposed between the first valve 60 and the nozzle end of the needle 52. A second needle 80 in the lower reservoir 12 has a second valve slidably mounted on its end.

The first valve 60 comprises a spherical stopper slidably mounted coaxially on the nozzle end of the needle 52.

The second valve comprises a second spherical stopper 70 mounted at its end.

The piston 8 includes a cylindrical recess 51 at its internal end 30 which is adapted to engage the needle 52.

The invention described herein describes a method of discharging fluid from a portable container (not shown) by utilizing a hand pump having an inlet 18 and an outlet 40 comprising:
(a) attaching a fluid conduit (not shown) from the inlet 18 to the portable container (not shown), where the hand pump 2 has a first and second fluid reservoir 10 and 12 respectively, and a fluid channel 14 therebetween;
(b) displacing a trigger 6 associated with the hand pump 2 so as to displace the piston 8 in a first reservoir 10 and:
   (i) open a first valve associated with the first reservoir 10 to discharge fluid in the first reservoir 10 to the outlet 40;
   (ii) close a second valve associated with the second reservoir 12 in the fluid discharge position; and
(c) displacing the trigger 6 associated with the hand pump 2 so as to displace the piston 8 in the first reservoir and:
   (i) close the first valve associated with the first reservoir 10;
   (ii) open the second valve associated with the second reservoir 12 so as to fill the first and second reservoir with fluid from the portable container in the fluid drawing position.

The piston 8 is repeatedly moved back and forth reciprocally between the open and close position so as to draw fluid from the fluid container into the second reservoir 12 and up into the first reservoir as the piston is moved back into the position shown in FIG. 5 and to discharge the fluid in the first reservoir through the nozzle 26 when the trigger is moved from FIG. 5 to FIG. 6 (whereby the second stopper or valve 70 closes the passage in the second reservoir 12).

It will be appreciated by those skilled in the art that other variations of the preferred embodiment may be practised without departing from the scope of the invention.

What is claimed is:

1. A hand pump adapted to discharge fluid from a portable container comprising:
(a) means for reversibly attaching the hand pump to the portable container;
(b) means for directing fluid from the portable container into a receiving container;
(c) means for allowing the fluid to flow from the portable container to the receiving container; and
(d) means for causing the fluid to cease flowing from the portable container to the receiving container.

2. The hand pump of claim 1, wherein the means for reversibly attaching the hand pump to the portable container comprise a fitting connected to the nozzle, wherein the fitting has a sealable adapter of a size and connection mechanism selected to reversibly connect to an opening in the portable container.

3. The hand pump of claim 1, wherein the means for directing fluid from the portable container into a receiving container comprises an elongated nozzle.

4. The hand pump of claim 1, wherein the means for allowing the fluid to flow from the portable container to the receiving container comprises:
(a) a body having an inlet, a handle, a lower reservoir, and an upper reservoir;
(b) a first passage extending from the inlet through the handle into the lower reservoir;
(c) a channel connecting the lower reservoir to the upper reservoir;
(d) a nozzle connected at a first end to the upper reservoir, having an outlet at an opposed second end;
(e) a second passage extending from the upper reservoir through the nozzle to the outlet;
(f) a piston having internal and external ends, the internal end disposed in one end of the upper reservoir;
(g) a fitting disposed between the upper reservoir and the spout;
(h) a first valve for opening and closing the outlet;
(i) an activator extending from the internal end of the piston through the upper reservoir, through the fitting and into the second passage through the nozzle, for opening and closing the first valve.

5. The hand pump of claim 4 wherein the activator comprises a needle extending from the internal end of the piston through the upper reservoir, through the fitting and into the second passage within the nozzle, wherein the needle has an annular protrusion at a medial position having an external diameter less than the internal diameter of the fitting.

6. The hand pump of claim 5 wherein the first value comprises a spherical stopper having a hollow central channel slidably connected to the needle within the second passage, wherein the external diameter of the stopper is greater than the internal diameter of the fitting.

7. The hand pump of claim 6 wherein a trigger is pivotally attached at a first end to the external end of the piston, and at a medial position to the handle, whereby movement of a second end of the trigger between an open position and a closed position effects inward movement of the piston and the needle to cause the protrusion to dislodge the spherical stopper from the fitting and allow fluid flow.

8. The hand pump of claim 5, wherein the means for causing the fluid to cease flowing from the portable container to the receiving container comprises:
(a) a first spring extending between the internal end of the piston and the first end of the fitting, wherein the first spring is in equilibrium in the trigger open position, and compressed in the trigger closed position;
(b) a second spring extending between the second side of the spherical stopper and the second end of the needle, wherein the second spring is in equilibrium state in the trigger closed position, and in a compressed state in the trigger open position.

9. The hand pump of claim 7 wherein the lower reservoir includes a positioner for positioning the second valve adjacent the first passage.

10. A hand pump adapted to discharge fluid from a portable container comprising:
(a) a handle having a handle passage extending therethrough;
(b) a nozzle having a nozzle passage extending therethrough;
(c) a fluid chamber having a lower fluid reservoir associated at one end with the handle passage and at the other end with a first end of an upper fluid reservoir, wherein a second end of the upper fluid reservoir is associated with the nozzle passage;
(d) a piston movable within the upper fluid chamber;
(e) a trigger pivotally attached at a first end to an external end of the piston, and at a medial position to a first end of the handle;
(f) a fitting disposed between the second end of the upper reservoir and the spout;
(g) a first needle extending through the upper reservoir from the internal end of the piston through the fitting into the nozzle passage;
(h) a first spring extending coaxially along the first needle from the internal end of the piston to the fitting;
(i) a first valve slidably mounted coaxially on the nozzle end of the first needle;
(j) a second spring disposed between the first valve and the nozzle end of the needle;
(k) a second needle in the lower reservoir having a second valve slidably mounted on its end;
(l) a fitting adapted for connection of the nozzle to a portable container.

11. A hand pump as claimed in claim 9 wherein the first valve comprising a spherical stopper slidably mounted coaxially on the nozzle end of the first needle.

12. A hand pump as claimed in claim 10 wherein the second valve comprises a second spherical stopper slidably mounted at its end.

13. A hand pump is claimed in claim 12 including a channel disposed between the upper fluid reservoir and lower fluid reservoir.

14. A hand pump as claimed in claim 13 wherein the piston includes a cylinder recess in its internal end, said recess adapted to engage said first needle.

15. A hand pump as claimed in claim 14 wherein the second spherical stopper includes a hole disposed partially therethrough for receiving said second needle.

16. A method of discharging fluid from a hand pump connected to a portable container said hand pump having an inlet and outlet comprising:
(a) attaching a fluid conduit from the inlet to the portable container;
(b) the hand pump having a first and second reservoir, and a channel there between;
(c) displacing a trigger associated with the hand pump so as to displace a piston in the first reservoir and:
(i) open a first valve associated with the first reservoir, so as to discharge fluid from the first reservoir to the outlet;
(ii) close a second valve associated with the second reservoir in a fluid discharge position;
(d) displacing the trigger associated with the hand pump so as to displace the piston in the first reservoir and:
(i) close the first valve associated with the first reservoir;
(ii) open the second valve associated with the second reservoir so as to fill the first and second reservoir with fluid from the portable container
in a fluid drawing position.

17. A method as claimed in claim 16 wherein the piston is repeatedly displaced between the fluid discharge and drawing positions so as to displace fluid from the portable container, and sequentially draw fluid from the portable container into the first and second fluid reservoirs and discharge fluid to the outlet.

18. A method as claimed in claim 17 wherein the first valve is moved by an activator associated with the piston.

19. A method as claimed in claim 18 wherein the second valve is moved by fluid pressure.

20. A method as claimed in claim 19 wherein said trigger is biased in the closed position.
